(19) United States
(12) Patent Application Publication
(10) Pub. No.: US 2004/0084442 A1
(43) Pub. Date: May 6, 2004

(54) Downhole electromagnetic heating tool and method of using same

(75) Inventor: Thomas A. La Rovere, Santa Barbara, CA (US)

Correspondence Address: John Russell Uren, P. Eng., Suite 202, 1590 Bellevue Avenue, West Vancouver, BC, V7V 1A7, CA

(73) Assignee: CANITRON SYSTEMS, INC.

(21) Appl. No.: 10/289,917

(22) Filed: Nov. 6, 2002

(51) Int. Cl. H05B 6/10

(52) U.S. Cl. 219/643; 219/635

(57) ABSTRACT

An induction tool for heating well casing and a method for using and manufacturing the tool. The tool comprises a magnetically permeability core and an electrically conductive coil surrounding the entire circumference of the core. The tool generates magnetic flux which flux is used to heat well casing adjacent to or acted upon by the tool. The heated well casing may be used to melt material used for well sealing.

This invention relates to a downhole electro-magnetic induction tool used in oil and gas wells and, more particularly, for a downhole induction tool used for heating and melting a eutectic alloy used for sealing the annulus spaces between well casings used in such oil and gas wells and for the process used with such a tool.

### BACKGROUND OF THE INVENTION

In oil and gas wells, the leakage of gas through casing cement conventionally used in such oil and gas wells is frequently a problem. The leakage is due to the porosity, fractures and other such discontinuities occurring within the cement. Such leakage can lead to casing failure, is a safety hazard to operating personnel, presents an environmental concern, and reduces efficient recovery of the desired oil and gas.

To counteract the effect of such leakages, the annular space can be filled with a substance over the cement that blocks the leakage of such gases through the cement. The material, conveniently a metal alloy eutectic material, is heated and melted within the annulus thereby forming a secondary seal or plug. The heating process to heat the substance may utilize an electrical resistance heating device to conductively and radiantly heat the casing in order to melt the alloy. However, electrical resistance heating is inherently unreliable and disadvantageous for this process.

Our recently issued U.S. Pat. No. 6,384,389 (Spencer) contemplated a tool used for melting a eutectic metal alloy within the annulus of an oil or gas well which tool used inductive rather than resistive heating. The use of induction for heating well casings is superior when compared to resistance heating. Lower power requirements, lower tool temperature and non-contact generation of heat in the casing are among the advantages. High tool temperatures cause thermal stresses that adversely affect reliability and limit casing temperature. Induction heating operates on the principle of heating the casing and not the tool itself. This allows higher casing temperatures while allowing lower temperature of the tool. This improves reliability and reduces power wasted in heating the tool thereby reducing overall process costs.

While the tool disclosed and illustrated in the '389 patent is contemplated as having many advantages, certain disadvantages have become apparent following investigations into the efficacy of the tool described therein. A number of improvements have been suggested.

The tool illustrated and disclosed in the '389 patent teaches a tool with a coil longitudinally wound around a laminated core stack. Electromagnetic theory teaches that magnetic flux flows circumferentially about an electric current in a conductor. Further, this theory teaches that current flow induced by the magnetic flux in an adjacent or secondary conductor flows parallel and in opposite direction to the current flowing in the primary conductor. In addition, magnetic flux paths as well as electric current paths must follow a closed loop. Thus, the current induced in the casing by the '389 tool primarily flows longitudinally in parallel alignment and adjacent to the coil conductors.

Due to the normal material variations in the magnetic and electrical characteristics over the length of the casing itself, the induced current flow is similarly variable and inconsistent. This results in proportional variations of heat generated in the casing and such inconsistent casing temperatures applied to the material intended to be melted are similarly inconsistent which results in non-uniform discontinuities in the melting process and potential re-solidification of the material used for the seal.

Further, the longitudinally oriented circulating current produced in the well casing by the tool described in the '389 patent is affected by discontinuities in the casing string. This is so because the casing tubes are joined by threaded couplings. The coupling joints create electrical and magnetic discontinuities due to cold working of the metal, the cutting of threads, oxidation and the like. The joints therefore increase electrical resistance thereby reducing electric current flow and consequential heat generation.

A further disadvantage of the longitudinally wound coil according to the '389 patent is that of variability and inconsistency of the induced current path in the casing due to the geometry of the windings. This problem is caused by the design of the longitudinally wound coil which necessarily limits the exposure of coil conductors to the casing on opposing sides. Since induced current flows principally parallel and adjacent to the primary conductors, significantly broad longitudinally oriented zones on the casing are minimally exposed to magnetic flux which limits the induced current flow. This results in non-uniform temperature zones on the casing surface and adversely affects the melting process and re-solidification of the material used for the seal.

Yet a further disadvantage of the longitudinally wound coil of the '389 patent relates to the variability and inconsistency of the of induced current path in the casing due to the geometry of the windings. The design of a longitudinally wound coil requires a significant ratio of conductor loops at the top and bottom ends of the coil. These loops are designed to extend beyond the high magnetic permeability core thereby reducing efficiency of the induction tool. Further, since the induced current in the casing must describe a closed path, parallel and adjacent to primary conductor, the induced current path in the casing is circuitous and not well defined at the coil ends. This results in non-uniform temperature zones on the casing surface and adversely affects the melting process and re-solidification of the material used for the seal.

A further disadvantage of the longitudinally wound coil of the '389 patent relates to the variability and inconsistency of the induced current path in the casing due to the geometry of the windings. The induced current in the casing must describe a closed path, parallel and adjacent to primary conductor. The induced current path in the casing is relatively long and circuitous and is not well defined at the coil ends. Since the path is long, the resistance is high. This acts to limit the induced current flow and heat generated in the casing and results in non-uniform temperature zones on the casing surface, again affecting the melting process and the re-solidification of the material used for the seal.

Yet a further disadvantage of the longitudinally wound coil, as described in the '389 patent is the variability and inconsistency of the induced current path in the casing due to the design geometry of the coil windings. Since the induced current path favors proximity to the adjacent primary conductors, there is a concentration of flux in the zone nearest to the coil conductor. This results in non-uniform temperature zones on the casing surface, thereby affecting the melting process and re-solidification of the material used for the seal.

Yet a further disadvantage of the tool illustrated and described in the '389 patent relates to encasing the longitudinally wound coil with a stainless steel tube. The tube provides a closed electrical path for induced current. Thus, heat will be generated in the tool itself reducing its efficiency and limiting its usefulness to heat the well casing. This problem was addressed by the inventors of U.S. Pat. No. 6,285,014. However, the tool proposed by the '014 patent suffers from many of the disadvantages hereinbefore described.

### SUMMARY OF THE INVENTION

According to a first aspect of the invention, there is provided apparatus for creating induction heat in well casing, said apparatus comprising magnetically permeable core material having a core longitudinal axis and which core material defines a longitudinal distance and an electrically conductive induction coil surrounding at least a portion of the entire circumference of said magnetically permeable core material and having a coil longitudinal axis concentric to said core longitudinal axis.

According to a further aspect of the invention, there is provided a method of heating electrically conductive well casing by inductively generating electric current in the casing utilising an induction coil, said coil surrounding the entire circumference of at least a portion of said magnetically permeable core material, said coil generating magnetic flux in said core material, and using said magnetic flux to induce electric current to generate heat in said well casing.

According to still yet a further aspect of the invention, there is provided a method of constructing a tool for use in heating well casing, said method comprising surrounding a magnetically permeable core material with an electrically conductive induction coil about the entire circumference of at least a portion of said core material.

According to still yet a further aspect of the invention, there is provided a tape wound core for an induction generating tool used in oil and gas wells comprising an electrically conductive induction coil surrounding a magnetically permeable core material, said core material comprising a continuous silicon steel material of a predetermined thickness, said coil being wound on a structural core pipe underlying said core material to a predetermined thickness so as to form said magnetically permeable core material.

According to still yet a further aspect of the invention, there is provided a spiral wound coil for an induction generating tool used in oil and gas wells comprising a magnetically permeable core material and an electrically conductive induction coil surrounding said core material, said coil being a flat spirally wound coil with an insulative coating to prevent electrical conductance between adjacent coils.

According to still yet a further aspect of the invention, there is provided a core end plate for a inductive tool having an electrically conductive coil surrounding magnetically permeable core material, said end plate being located on at least one end of said magnetically permeable core material, said end plate being made of magnetically permeable material and operable to promote the transmission of magnetic flux lines generated by said core material.

According to yet a further aspect of the invention, there is provided a temperature sensor for an inductive heat generating tool used in oil and gas wells which tool comprises magnetically permeable core material and an electrically conductive induction coil surrounding said core material, said temperature sensor comprising a coil wound around said core material. In a preferred embodiment of the invention, the temperature sensing coil is made from twisted bifilar wire which is twisted to cancel the effect of electromagnetically induced currents generated by the heating tool in the temperature sensing wire. In a further preferred embodiment, the temperature sensing coil is electrically connected to resistance measuring electronics used to measure the change in resistance of said bifilar wire which is proportional to the temperature of the coil material thereby to determine the temperature of the core.

According to yet a further aspect of the invention, there is provided a temperature sensor for an inductive heat generating tool used in oil and gas wells, said tool comprising a magnetically permeable core material and an electrically conductive induction coil surrounding said core material, said temperature sensor comprising a sensor coil wound around the induction coil. In a preferred embodiment of the invention, the sensor coil is made from bifilar wire which is twisted to cancel the effect of electromagnetically induced currents generated by said tool in the temperature sensing wire. In a further preferred embodiment, the temperature sensing coil is electrically connected to resistance measuring electronics which measures the change in resistance of the bifilar wire which is proportional to the temperature of the coil material thereby to determine the temperature of the induction coil.

According to still yet a further aspect of the invention, there is disclosed an induction heat generating tool, said tool comprising at least two substantially identical modular reactor units, each of said reactor units comprising a central core tube, a tape wound core, a core end plate, an inductor coil, at least one bifilar wound temperature sensing coil, at least one magnetic flux sensor coil, at least one current sensing coil and at least one voltage sense coil.

According to still yet a further aspect of the invention, is provided casing measurement apparatus to measure the temperature of casing in an oil or gas well subject to inductive heating by an inductive heating tool having an electrically conductive induction coil, said apparatus comprising a flux sensing coil, a current sensing coil, a voltage sensing coil, a core temperature sensing coil and an induction coil temperature sensing coil. In a preferred embodiment, signals representing flux, current, voltage and temperature of the core and electrically conductive induction coil determine the electrical power phase shift of the induced current in the casing which phase shift is proportional to the casing permeability and which permeability is calibrated with respect to temperature.

According to yet a further aspect of the invention, there is provided an inductive heating tool for inductively heating at least two concentric well casings of an oil or gas well comprising an inductive generating tool to generate magnetic flux, a tool flux sensor to measure the flux generated by said tool and a flux saturation sensor to determine the flux saturation of a first and inner well casing.

According to still yet a further aspect of the invention, there is provided a method of inductively heating at least two concentric casings of an oil or gas well comprising generating flux from an inductive heating tool, determining the flux saturation value of the inner one of said at least two concentric casings, increasing the flux generated by said tool to a value above said flux saturation of said inner of said two concentric casings such that said increased flux generated by said tool will pass to and heat the outer one of said two concentric casings of said oil or gas well.

According to still yet a further aspect of the invention, there is provided a centralising stopper member for attachment to a downhole tool in a well casing comprising a collar attached to the periphery of said tool, said collar acting as a centraliser and extending outwardly from said tool, said centraliser being operable to center said tool within said casing.

According to still yet a further aspect of the invention, there is provided a stopper member for attachment to the periphery of a downhole tool used in well casing, said stopper member comprising a collar attached to said periphery and extending outwardly from said tool, said stopper being operable to impede fluid flow between the induction tool and the casing thereby to reduce heat transfer from said casing.

According to still yet a further aspect of the invention, there is provided a downhole tool used for heating a well casing and having a central bore therethrough, said bore extending the length of said tool and allowing the passage of electrical equipment from above to below said tool.

According to yet a further aspect of the invention, there is provided a well heating tool to heat well casing within an oil or gas well, said tool comprising oil and electrical connections within said tool, said oil being operable to insulate said electrical connections and to provide pressure compensation for electrical interface connectors between said tool and the downhole electrical cable.

According to yet a further aspect of the invention, there is provided a bladder in a downhole well heating tool for pressure compensating high dielectric oil used to fill said tool, said bladder being operable to equalize the internal pressure of said tool relative to external downhole pressure in said casing, said equalization taking place for compensating for the temperature coefficient of expansion of said dielectric oil over the operating temperature range of said tool.

According to a further aspect of the invention, there is provided a downhole electromagnetic induction tool for a well and a data acquisition and telemetry unit mounted on said tool, said data telemetry unit being operable to collect and transmit data relating to downhole conditions from said tool to the surface of said well, said data telemetry unit being operable to control electric power applied to said tool.

According to yet a further aspect of the invention, there is provided a downhole electromagnetic induction tool for generating flux into a well casing by power supplied by a single phase power supply, said tool comprising at least two reactor modules assembled together to utilise said single phase power supply, said reactor modules being connected in series or reverse-alternating-series thereby to lower downhole cable loss and minimize electromagnetic coupling losses between adjacent reactor modules.

According to yet a further aspect of the invention, there is provided a downhole electromagnetic induction tool for generating flux into a well casing by power supplied by a three phase power supply, said tool comprising at least two reactor modules assembled together to utilise said three phase power supply, said reactor modules being connected in parallel or in series-parallel.

### BRIEF DESCRIPTION OF THE SEVERAL VIEWS OF THE DRAWINGS

Specific embodiments of the invention will now be described, by way of example only, with the use of drawings in which:

FIG. 1A is a diagrammatic side view of an inductive heating tool used to generate heat in a well casing according to the PRIOR art;

FIG. 1B is a diagrammatic view taken along IA-IA of FIG. 1A;

FIG. 2 is a partial diagrammatic side view of an offshore oil or gas well and further illustrating a single inductive heating tool in position within the well casing according to the invention;

FIGS. 3A and 3B are diagrammatic side and plan views, respectively, of the inductive heating tool according to the invention;

FIG. 3C is a diagrammatic plan view of the core pipe used for supporting the magnetically permeable core material according to the invention particularly illustrating the recess channels in the core pipe providing passageways for the electrical power busses, sensor and data acquisition cables;

FIG. 4 is a diagrammatic side view of a plurality of inductive reactor modules assembled as a tool and used for well casing heating according to the invention;

FIG. 5 is a diagrammatic side view of the inductive heating tool according to the invention with a power control unit(PCU) located on the surface which PCU is used for applying and controlling power applied to the inductive heating tool;

FIGS. 6A through 6E are diagrammatic side views of different end core configurations for the heating tool of FIG. 3A which may be used to enhance flux transfer from the inductive heating tool to the well casing according to the invention;

FIG. 7A is a diagrammatic side view illustrating a twisted bifilar cable used to sense the temperature of the reactor module according to the invention;

FIG. 7B is a diagrammatic side view illustrating sensor coils wound about the circumference of a reactor module and being used for sensing the temperature of the core and inductor coil, the flux intensity at the middle and one end of the reactor, the inductor coil voltage and the inductor coil current;

FIG. 8 is a diagrammatic schematic view of the reactor module induction coil with an additional current sensing coil and differential amplifier circuit used to determine inductor coil phase shift and casing temperature;

FIG. 9 is a diagrammatic side view of the electromagnetic tool in position within the well casing and utilizing a centralizing stopper with a mounting collar according to a further aspect of the invention;

FIG. 10 is a diagrammatic side view of the electromagnetic tool according to the invention and further illustrating a data telemetry unit mounted on the end of the tool according to a further aspect of the invention;

FIG. 11A is a diagrammatic side view of the tool assembly reactor modules indicating a preferential orientation of mating couplings;

FIGS. 11B and 11C are diagrammatic plan views of mating male and female reactor module end couplings which indicate preferential alignment and designations of core pipe channels used to route power busses through the reactor modules;

FIG. 11D is a diagrammatic end view illustrating a preferential buss bar link used for linking buss bars within the reactor module end couplings; and

FIG. 11E is a diagrammatic schematic of a heating tool assembly illustrating a single phase alternating reverse wiring configuration used for causing the direction of magnetic flux at each end of adjacent reactor modules to be oppose thereby directing flux more directly toward the casing.

### DESCRIPTION OF SPECIFIC EMBODIMENT

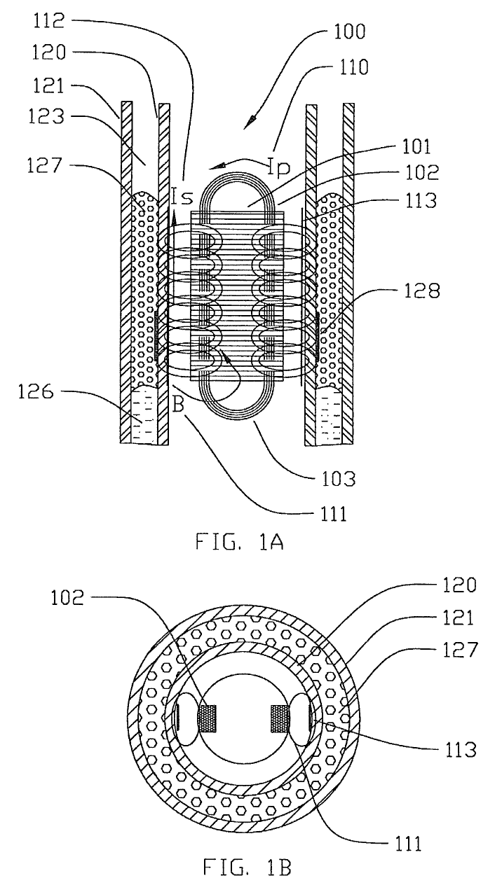

Referring now to the drawings, there is provided a well inductive heating tool generally illustrated at 100 according to the PRIOR ART which tool is illustrated in FIG. 1. Such a tool is illustrated and described in our U.S. Pat. No. 6,384,389, the contents of which are disclosed herein by reference.

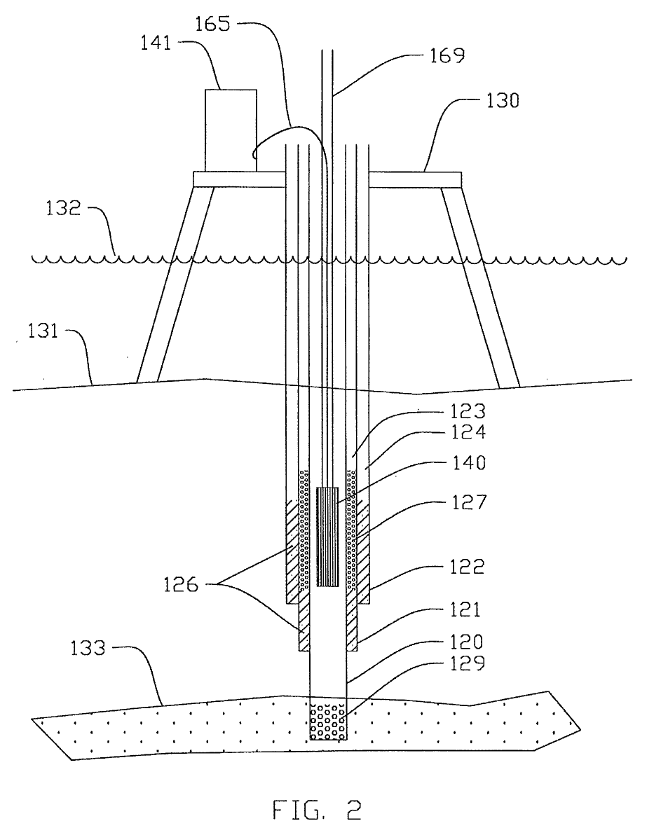

The well inductive heating tool 100 is used for downhole well heating as will be described further in association with FIG. 2. However, the tool 100 illustrated in FIGS. 1A and 1B comprises a laminated magnetically permeable core 101 with the core laminations running orthogonal to the axis of the tool 100 and casing 03 120 and with coil windings 102, 103 which are wrapped about the core 101 in a direction normal to the direction of the laminations made from the magnetically permeable material of core 101.

The tool 100 is lowered and positioned to desired depth into the circumferential well casing 120. Electric current is applied to the coil windings 102. The instantaneous primary electric current direction is indicated by “I_{P}” numerically illustrated at 110.

In accordance with Ampere's Law, (popularly known as the Right Hand Rule), the instantaneous magnetic flux indicated by the symbol “B” and numbered 111 is thereby generated about the coil windings 102, 103 in a circumferential path about the conductors.

Since the casing 120 is a closed loop electrical conductor, the magnetic flux 111 induces a secondary electric current, as indicated by the symbol “Iₛ” and numbered 112 to flow in accordance with classic electromagnetic theory based on Faraday's Law. The secondary current Iₛ 112 is proportional to and in opposite direction to the instantaneous primary current Iₚ. The heat generated in the casing is proportional to the induced power dissipated based on Ohm's Law which relates the current and resistance of the electrical path according to the formula:

P=I²R (1)

where P represents the power dissipated, I represents the electrical current, and R represents the resistance of the electrical path. The heat induced in the casing is intended to be used for various purposes, the most germane of which is for melting a material that can be used to seal the annulus of a well casing, or to provide a secondary seal for repairing leaks in primary seal materials used in oil well installations such as cement 126, which typically surrounds the outside of the casing 120 and which cement is used to prevent gas or oil leakage in the annulus 123 surrounding the well casing 120.

There are disadvantages with the tool 100 illustrated in FIGS. 1A and 1B. First, since the coil windings 102 and 103 generate a magnetic flux field about the coil, the electromagnetic field strength varies inversely with the distance of the winding from the point of flux measurement. Accordingly, more flux will be generated nearer the windings than at a point further away from them. This results in more heat being generated in the well casing 120 nearer the windings 102 as particularly shown in FIG. 1B and results in discontinuous zones in heat flow or “hot spots” 113 around the well casing 120. The effect of these hot spots 113 are discontinuities in the melting of the eutectic material 127. The seal created from this non-uniform melting exhibits a non-uniform composition which adversely affects seal integrity.

A second disadvantage results from normally occurring discontinuities in the pipe used in the well casing 120. Casing coupling joints 128, for example, have a higher electrical resistivity than at areas of the casing 120 where no joints appear. Likewise, the composition of the casing 120 itself may not be uniform again resulting in differences in resistance to longitudinal current flow in the pipe. These resistance anomalies affect efficient current flow and adversely affect the even and constant induction heating of the casing 120.

Yet a further disadvantage of the PRIOR ART tool 100 is that space for the heating tool 100 is limited by the internal diameter of the well casing 120. If it is intended to increase the power of the tool by increasing the number and quantity of windings 102, increasing the diameter is precluded because of the restricted tool space available within the well casing 103.

Yet a further disadvantage of the PRIOR ART tool 100 is due to the manufacturing costs to produce the stacked lamination core. In practice, various diameters of tools are required to efficiently heat casings in wells with different diameters, thus requiring special tooling to produce various lamination components in addition to the labor intensive assembly required.

Finally, the tool illustrated and described in the '389 patent earlier referred to is itself housed within a stainless steel housing (not illustrated). The steel housing itself is subject to inductive heating by the flux generated. This results in significant inefficiencies since the heat generated in the housing imposes internal heat upon the tool components limiting its operational performance range and reliability. Additionally, some of the flux that is intended to flow through the casing is shunted thereby wasting energy that could otherwise be used to heat the well casing 103.

Reference is now made to FIG. 2 where the tool 140 according to the present invention is illustrated as being located within the well casing 120 at some distance below the sea floor 132 in a typical offshore application. The well platform is supported above sea level 132 resting on the ocean floor 131. A power control unit (PCU) mounted on the well platform 141 is supplied to apply and control electric power to the tool 140. A plurality of casings are used in this example, namely the tertiary or largest casing 122, a secondary casing 121 and the production casing 120 which extends to the reservoir or oil or gas producing area of interest 133. Perforations 129 are provided in the lower end of the well casing 120 to allow the entrance of oil and/or gas which then is conveyed to the surface as is known.

As each casing ends and the successive interior casing commences, cement is used to seal the respective annuluses outside the respective casings. For example, cement 126 is used to fill the annulus 124 between the secondary casing 121 and the tertiary casing 122 and further cement 126 is used to fill the annulus 123 between the secondary casing 121 and the production casing 120.

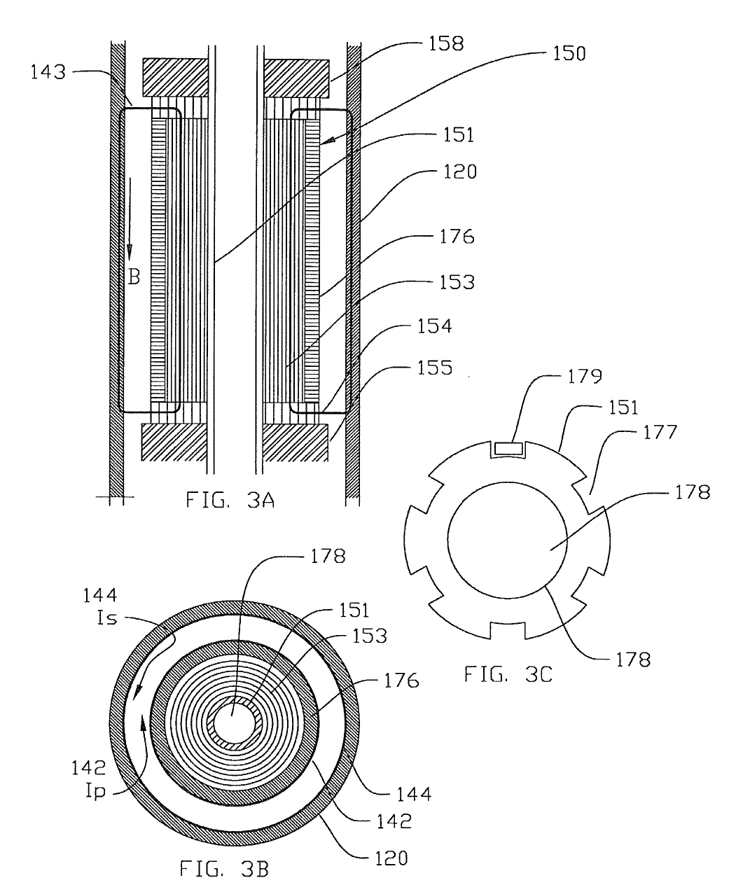

The induction heating tool 140 according to the present invention is illustrated in greater detail in FIGS. 3A, 3B and 3C. A core pipe 151 preferentially made from non-magnetic stainless steel is used as the core for the reactor module 150 and supports the tape wound core 153 as well as defining a bore 178 extending the length of the reactor module 150. Silicon steel, commonly known as transformer steel, conveniently having a thickness of 0.014 inch, is wound about the core pipe 151 in a continuous sheet so that a tape wound core 153 is formed from the silicon steel which core 153 has a high magnetic permeability along its longitudinal axis. An induction coil 176 surrounds the tape wound core 153 and is conveniently made from an insulated flat conductor material which is spirally or solenoid wound from the top of the tape wound core 153 continuously about the entire circumference of the tape wound core 153 a predetermined length of the tape wound core 153. The outside diameter of the tool 150 is defined by the outside of the spiral wound coil 176. Core end plates 154 are also fitted at each end of the tape wound core 153, each having an outside diameter designed to minimize the magnetic air gap between the outside diameter of the reactor module 115 and the inside diameter of the casing 120.

The core pipe 151 about which the sheet silicon steel is wound may conveniently take a configuration as illustrated in FIG. 3C, with recess channels 177 illustrated in addition to the bore 178 to provide passageways for insulated electrical power buss conductors 179 sensor and data acquisition cables can be routed through the length of the reactor module 150 of the assembled tool 140. The recesses 134 provide an advantageous design feature in order minimize the distance between the induction coil 176 and the casing 120. They serve as channels for the flow of pressure compensating high dielectric fluid 161 within and between reactor modules 150 and they provide a degree of electromagnetic shielding for the sensor and data acquisition cables routed through them.

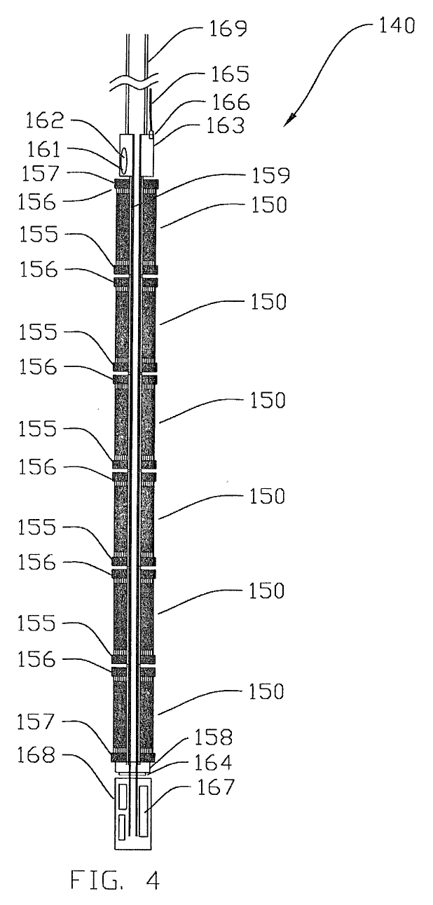

With reference now to FIG. 4, a downhole electromagnetic induction heating tool 140 is configured and assembled by a series of identical reactor modules 150, each reactor module being similar to the reactor module 150 as illustrated in FIGS. 3A-3C. The reactor modules 150 are connected, one to another by means of male and female mating connection couplings 155, 156, respectively. These connections 155, 156 are part of each reactor module 150.

A central support tube 159, preferentially made from stainless steel, extends through the bore 178 of each reactor module core pipe 151, the length of which is determined by the number of reactor modules 150 assembled together to form the tool 140. The uppermost reactor module coupling 150 preferentially mates with and attaches to a male tool end coupling 157 and a support tube adapter 163 for connection of the tool 140 to downhole production tubing 169 or to a cable (not shown) conveniently used for the purpose of positioning the tool to a position within the well as may be desired.

The male reactor module coupling 157 on the lowermost reactor module mates with and attaches to a female tool end coupling 158. The bottom is preferentially secured to the central support tube 159 by means of a tool bottom clamp nut 164. The reactor modules 140 may be electrically connected for use with either a poly-phase or single phase power supply. The connection of a downhole electric power cable 165 to the heating tool is made by means of an downhole electrical power connector 166 installed to the male tool end coupling 157.

A downhole data acquisition and telemetry electronics unit (DTU) 167 is contained within a pressure vessel 168 located beneath the tool bottom clamp nut 164 to provide measured temperature, voltage, current and flux data from the tool 140 to the PCU for process control and analysis purposes.

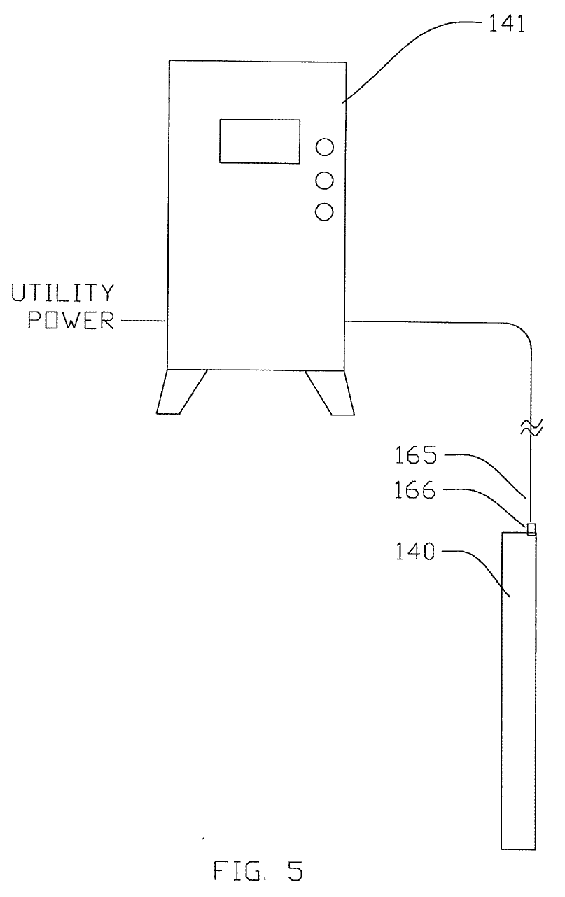

The power control unit or PCU 141 (PCU) (FIG. 5) is located on the well platform 130 (FIG. 2) and the three phase electrical cable 165 extends to the tool 140 within the production casing 120. The power control unit 151 provides and regulates the electric power applied to the tool string 140 as required to achieve and maintain the temperature of the casing 120 required to melt the eutectic alloy material 127. The PCU also integrates with various electrical monitoring devices so that the position of the tool 140 within the well casing 120 and the power provided to the tool 120 may be determined. Sensing devices can be used to monitor and predict the necessary power to be applied to the tool depending on the size and position of the secondary or tertiary casings within which the tool 120 140 is intended to be positioned during operation may also be provided within the power control unit 141.

### Operation

In operation, the appropriate number of reactor modules 150 are mechanically assembled and electrically connected by means of reactor module mating male and female support couplings 155, 156, respectively, as is shown in FIG. 4. The assembled tool string 140 can be suspended by a downhole support pipe such as oil well production tubing 169 or by a cable (not shown) within the production casing 120 (FIG. 2) and lowered to its desired position where heating is intended to occur. The desired position may be ascertained by means of various types of sensors typically used in oil wells to locate subterranean features. It will be noticed that the central support tube bore 181 that extends throughout the length of the tool 140 allows water and other well fluids to pass through the tool 140 thereby eliminating developing pressure while the tool is inserted or extracted due to the restricted gap between the tool 140 and the production casing 120.

When the tool string 144 is properly positioned within production casing 120, power will be applied to the induction coils 176 from the power control unit 141 through the power cables 165 (FIG. 5). The power applied to the tool string induction coils 176 is regulated based on reactor module temperature reported by the DTU 167.

The induction tool 140 is intended to raise the temperature of the production casing 120 to a degree that heat radiating outward from said casing will cause the eutectic material 127 located within the annulus spaces to uniformly melt and form a seal when the material again solidifies. Likewise, if the use of the tool 140 is intended to reduce the viscosity of the fluid or gas flowing from the formation and thereby enhance recovery, the power will be applied as has been previously determined to have the most efficacy for the enhanced recovery of oil and/or gas.

The manufacture of the tape wound core 153 illustrated in FIGS. 3A and 3B is of interest. Whereas previous cores have been made by individual sheets of magnetically permeable material laminated together to form the core, it is contemplated that a single sheet of 0.14 inch non-oriented high permeability silicon steel material could conveniently be used. One end of the steel material is conveniently connected to the core pipe 151 by spot welding or the like and the material is simply wound onto the core pipe 151 by rotating the core pipe 151 and maintaining the sheet steel material under appropriate tension during the core pipe rotating process until the desired diameter of the core 153 is reached, which process would desirably give a 95-98% steel fill value for the core 153. Although the silicon sheet material is conveniently non-oriented, grain oriented steel would be magnetically advantageous and useful if available with an orientation normal to the direction of the roll.

With the grains oriented normal to the core pipe 151 in the sheet material, the core would have a higher permeability in it's longitudinal direction thereby enhancing the flux flow through the material in the preferential axial direction.

The spiral wound coil 176 is preferably made from a flat electrical conductor with a high temperature type resin coating spirally or solenoid wound about the tape wound core 132. The use of the flat electrical conductor as coil material reduces the interstitial gaps otherwise present with the usual round electrical conducting wire material typically used and thereby provides a higher magnetic flux density emanating from the core material because of the greater number of conductor turns within a unit coil size.

The two core end plates 154 for reactor module 150 are conveniently also made from the sheet silicon steel material used for the tape wound core 153. This material is wound with an inside bore dimensioned to assemble to the core pipe 151, it being noted that the outside diameter of the end plates 154 is preferably at least the same dimension as the outside diameter of the spiral wound coil 176. The end plates 154 provide a high permeability path for the flux emanating from the core 153 and help to direct flux toward the well casing 120. By providing a low reluctance, high permeability path, as well as reducing the air gap between the ends of the core 153 and the casing 120, the density of the flux passing to the production casing 121 is increased thereby enhancing induction heating of the casing 120.

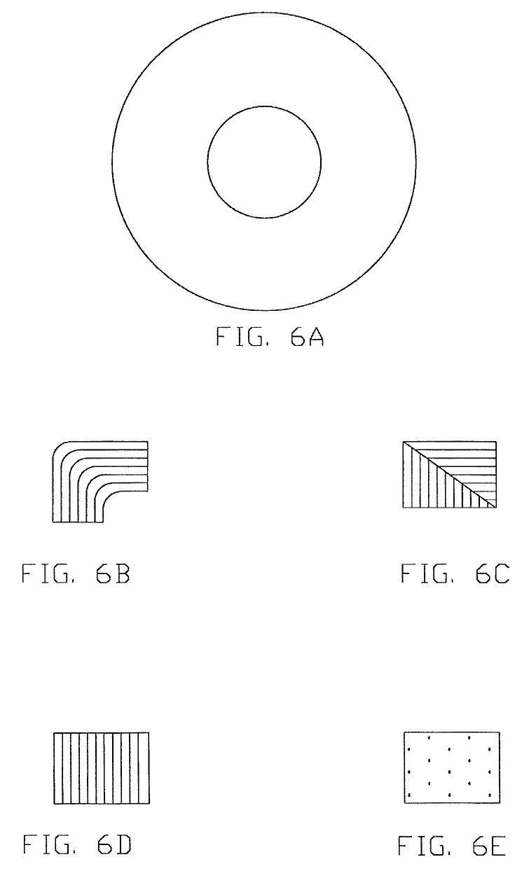

In a similar manner, core end plates 154 could take alternative configurations as illustrated in either of FIGS. 6B, 6C or 6D. FIG. 6A is a plan view that indicates the circular shape with an bore to allow it to be assembled over the core pipe 151. FIG. 6B represents a profile view of a core end plate manufactured by form stacking sheets of high permeability non-oriented silicon steel. FIG. 6C represents a profile view of a core end plate manufactured by miter joining a tape wound core and a stacked lamination core components both made from high permeability non-oriented silicon steel. FIG. 6D represents a profile view of the tape wound core end plate heretofore described made from high permeability non-oriented silicon steel. FIG. 6E represents a profile view of a core end plate manufactured from a high permeability sintered metal process.

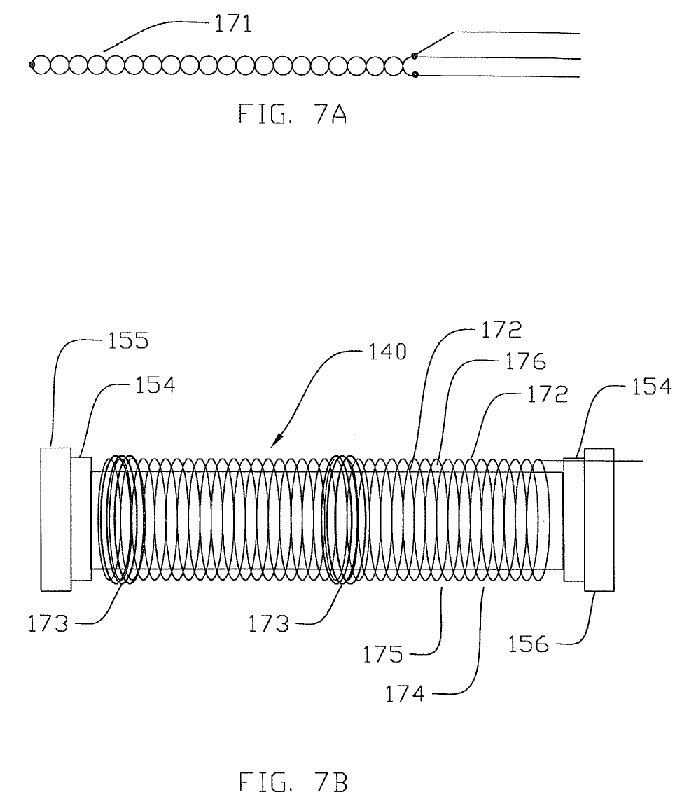

Each of the FIGS. 6B-6E configurations reduce the magnetic reluctance path and thereby promotes flux emanating from the core 153 to the casing 120. In a further embodiment of the invention, reference is made to FIGS. 3A, 7A and 7B, where temperature measurement of the induction coil 176 and core 153 (FIG. 2) may be obtained.

Twisted bifilar wire cables 171 (FIG. 7A) having two twisted conductors in order to cancel out the generation of any induced current in the wire 171 are spirally wound around the diameter of the tape wound core 153 and likewise the induction coil 176. The resistance of the bifilar twisted wire cables 171 are measured during operation to provide the temperatures of the tape wound core 153 and of the induction coil 176. As is indicated in FIG. 7A, the wires are connected to the instrumentation electronics using a Kelvin connected cable in order to reduce measurement errors otherwise introduced by the length of the connecting cable. Since the resistance of the bifilar wire 171 increases proportionately with temperature, the temperatures of the coil 176 and of the reactor tape wound core 153 are obtained. Such temperature measurements are useful since the power being applied to the tool 140 can be accordingly controlled in order to achieve a predetermined temperature set point and to prevent overheating of the tool 150 components. Further, temperature data on the coil 176 and the tape wound core 153 is useful to compile a database of various operating conditions which can be used for further and different applications of the same nature.

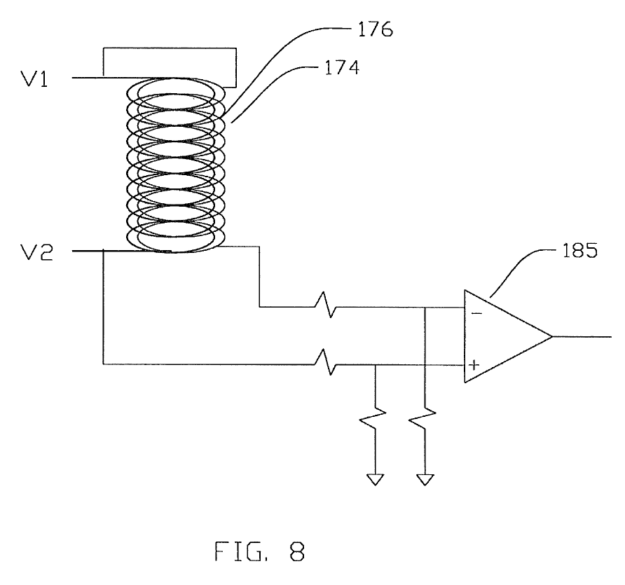

In a further embodiment of the invention, it may be desirable to indirectly determine the temperature of the casing 120 which is subject to the inductive heating created by tool 140. This process proceeds by determining the change in permeability of the casing 120 relative to the change in temperature that has been calibrated with a database correlating material permeability with respect to temperature. In this process and with reference to FIGS. 7B and 8, data from sense coils wound circumferentially about the reactor module 150 are utilized to determine power line phase shift relative to permeability.

The coils include the bifilar twisted temperature sense coils 172 wound about and to measure the temperatures of the tape wound core 153 and the induction coil 176, the two flux sense coils 173 wound at the middle and at the end positions of the induction coil 176, the current sense coil 174 wound about and connected at one end to the inductor coil 176 and the voltage sense coil 175 wound about the length of the inductor coil 176. The induced voltage waveforms in the above indicated sense coils are therefore measured and transmitted by the DTU 167 and signal processed by the PCU 151 controller to determine the phase shift of the power applied to the inductor coil 176 and induced to the casing 120. Since this sensed current represents the induced coil current, the current in casing 120 can accordingly be inferred. The phase shaft is proportional to the increased temperature in the casing 120. Look up tables and/or other calibration data may be used to determine a value for the temperature of the actual casing 120.

In yet a further embodiment of the invention, it may be desirable to heat a secondary casing 121 by means of first magnetically saturating the production casing 120. This may be beneficial, for example, where gas or oil leakage through cement is discovered in a secondary 124 or tertiary annulus 125 separated but concentric to the production casing 120. In this technique, the permeability of the casing material is known to be significantly less than the tape wound cores 153 of the tool 150. The core 153 is operated at a temperature considerably less than the temperature induced ed in the casing 120. The permeability of the low carbon steel casing 120 decreases with increasing temperature and therefore the casing 120 becomes magnetically saturated at a much lower flux density than does the tape wound core 153. The “excess” flux after the production casing 120 has become saturated must therefore extend preferentially towards and into the next magnetically low reluctance path, since, in a manner analogous to electric current flow, magnetic flux must follow a closed path. If the permeability of the tape core 153 is known as well as the permeability of the production casing 120, power can be applied to the tool 140 to further drive the production casing into saturation and thereby induce current in a secondary casing 121 to generate heat.

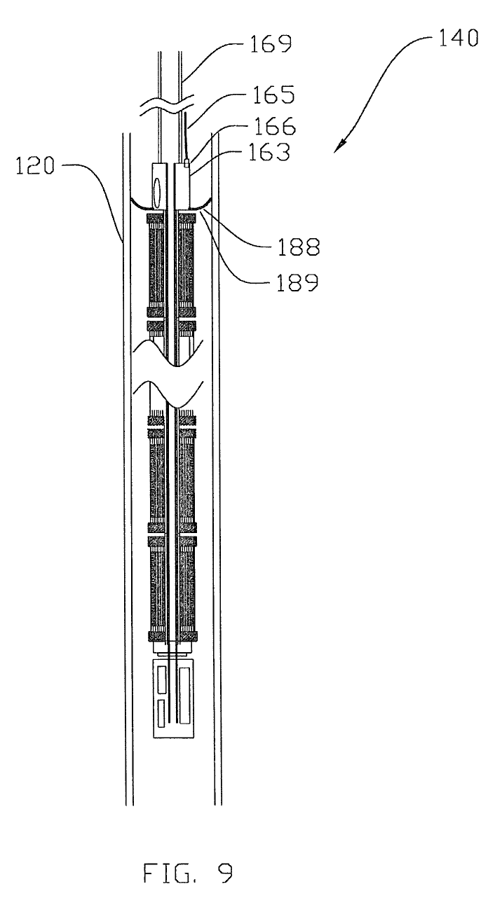

In a further embodiment of the invention and with reference to FIG. 9, a centralising tool is generally illustrated at 188 which may also include a fluid stopper 189, preferentially mounted at the top of the tool 140. The centralising stopper is mounted about the periphery of the outside diameter of the tool 140. The use of the centralising tool 200 allows the tool 120 to be more properly concentrically positioned within the inside diameter of the casing 120 so that the gap between the tool 120 and the casing 111 is equalized in order to maximize uniformity of flux paths between the tool reactor modules 140 ant the casing 120.

The stopper device 189 further provides a barrier to liquid flow between the tool 150 and the casing 120. The flow of liquid is preferably minimized since fluid due to thermal convection caused by heat induced in the casing 120 contributes to cooling of the casing 120 as cooler water and/or other downhole fluids are convectively drawn upward. The stopper 189 on tool 200 is conveniently mounted to the support tube adapter 163 and the tool 140.

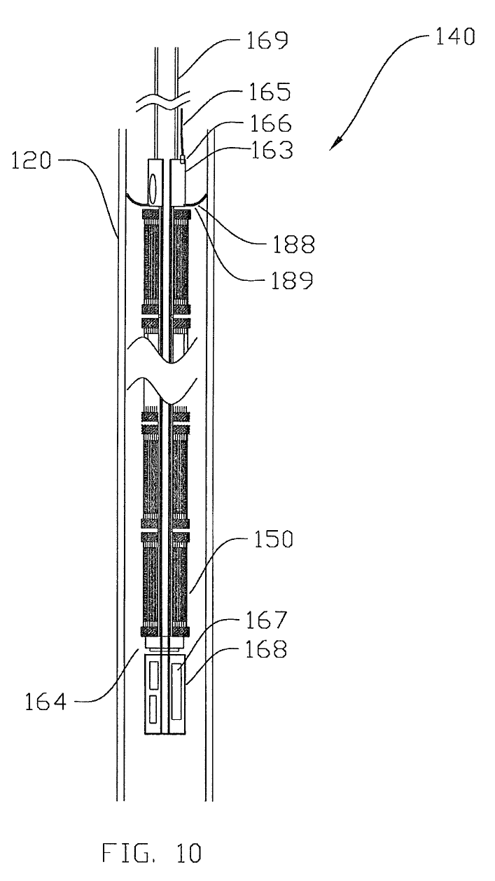

A data telemetry unit (“DTU”) generally illustrated at 167 is physically attached at the bottom of the tool 140 as illustrated in FIG. 10. The DTU 167 is enclosed within a pressure vessel 168 and provides multiple channels of analog and digital signal conditioning and processing for transmission to the surface PCU 141 (FIG. 2). Downhole measured data includes tool temperatures, inductor coil voltages, currents and the like as may be required. The DTU 167 further conveniently includes a power supply, a signal conditioning programmable logic device (“PLD”), analog to digital conversion and power line carrier transmitter electronics, all of which may be used, in order to transmit serial data packets to the surface PCU controller 141 via the downhole power cable 165 (FIG. 4).

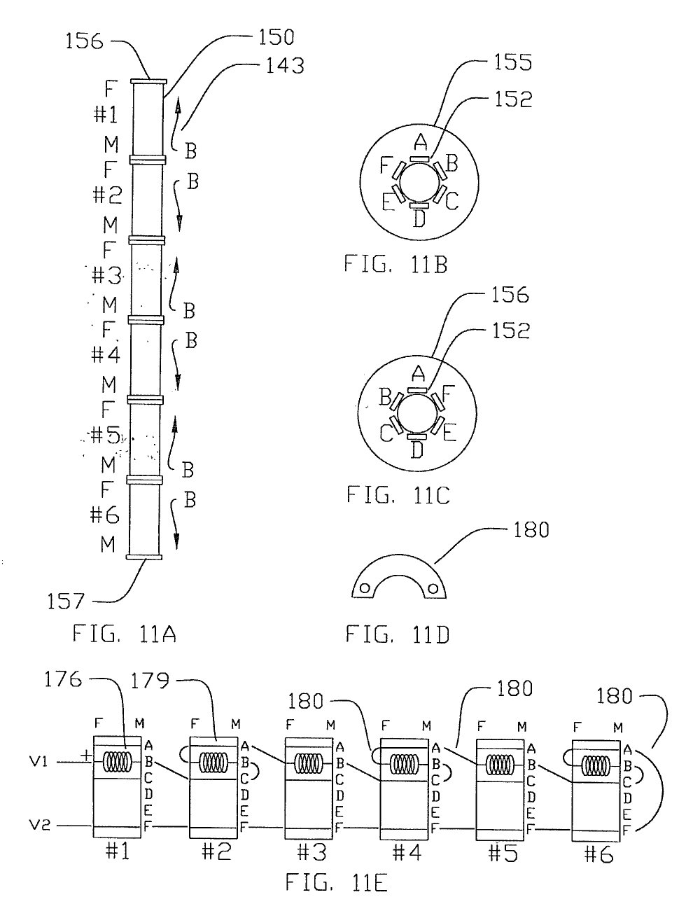

The operation of the tool 120 conveniently utilizes either a polyphase or single phase utility electric power source at 50/60 Hz. FIG. 11E indicates a preferential single phase reverse alternating series connection scheme. This configuration is advantageous since the higher effective series resistance of the inductor coils 176 allows a higher voltage and correspondingly lower current to be used to achieve a given power level applied. Higher applied voltage minimizes losses due to the long downhole power cable required to position the tool in typical downhole applications thereby providing higher tool efficiency. Each reactor module 150 includes configurable power buss bars 180 to allow appropriate connection of the induction coils 176 of the reactor modules 150 to either single phase or polyphase power sources.

The buss bars 180 would conveniently further allow the coils 176 of the tools 140 to be selectively connected such that the longitudinal aligned magnetic polarity of each reactor module 150 can be configured with respect to adjacent modules as best seen in FIG. 11A which illustrates the opposing instantaneous flux directions “B” 143 generated by each reactor module 150. This allows the preferred configuration using single phase power with each adjacent core end having like opposed magnetic poles. The configuration contributes to the promotion of flux emanating from the end of each core of each tool 150 such that the flux is more efficiently directed toward the well casing 120 (FIG. 9) rather than into reactor module couplings 155 and 156, or into adjacent reactor cores. Minimizing stray flux from passing through the reactor module end couplings 155 and 156 is desirable since the couplings are necessarily made from electrically conductive metal material which would be subject to induced current flow and would generate heat thereby reducing the operating efficiency of the tools 140.

Yet a further aspect of the invention is directed towards the configuration of the individual reactor modules 150 which reactor modules 150 are intended to be interchangeable. Each of the reactor module 150 end couplings 155, 156 and tool end couplings 157, 158 are designed to have a common mounting configuration and dimensional features such as o-ring seals 160 throughout the tool string 140. By providing reactor modules with common mounting configurations, the repair and replacement of individual reactor modules 150 will be facilitated and the production costs per unit will be reduced.

While the principal focus of the present invention has been on the use of the tool 140 as an inductive heating tool to melt an alloy and thereby form a seal in the annulus of a well casing over a leaking cement seal, it is contemplated that the heating provided by the tool may well be useful for other purposes in the oil and gas industry and, more particularly, in the heating of well casing to promote enhanced recovery of oil and gas from a formation where it is desirable to heat the formation to assist fluid flow through reduced viscosity. Indeed, many other applications for the inductive tool even outside the oil and gas industry might usefully be achieved through the use of flux generated by the efficiencies of the tool according to the present invention.

A eutectic metal mixture, such as tin-lead solder is conveniently used because the melting and freezing points of the mixture is lower than that of either pure metal in the mixture and, therefore, melting and subsequent solidification of the mixture may be obtained as desired with the operation of the induction apparatus 111 being initiated and terminated appropriately. This mixture also bonds well with the metal of the production and surface casings 102, 101. The addition of bismuth to the mixture can improve the bonding action. Other additions may have the same effect. Other metals or mixtures may well be used for different applications depending upon the specific use desired. For example, it is contemplated that a material other than a metal and other than a eutectic metal may well be suitable for performing the sealing process.

For example, elemental sulfur and thermosetting plastic resins are contemplated to also be useful in the same process. In the case of both sulfur and resins, pellets could conveniently be injected into the annulus and appropriately positioned at the area of interest. Thereafter, the solid material would be liquefied by heating. The heating would then be terminated to allow the liquefied material to solidify and thereby form the requisite seal in the annulus between the surface and production casing. In the case of sulfur pellets, the melting of the injected pellets would occur at approximately 248 deg. F. Thereafter, the melted sulfur would solidify by terminating the application of heat and allowing the subsequently solidified sulfur to form the seal. Examples of typical thermosetting plastic resins which could conveniently be used would be phenol-formaldehyde, urea-formaldehyde, melamine-formaldehyde resins and the like.

Many modifications in addition to those specific embodiments disclosed and suggested will be contemplated by those skilled in the art to which the invention relates and the present embodiments are given by way of example only and are not intended to limit the scope of the invention as set forth in the accompanying claims.

We claim:

1. Apparatus for creating induction heat in well casing, said apparatus comprising magnetically permeable core material defining a longitudinal distance with a core longitudinal axis and an electrically conductive coil surrounding at least a portion of the entire circumference of said magnetically permeable core material, said coil having a coil longitudinal axis concentric to said core longitudinal axis.

2. Apparatus as in claim 1 and further comprising a central bore opening extending the length of said magnetically permeable core material to allow passage therethrough.

3. Method of heating electrically conductive well casing by inductively generating electric current comprising operating an electromagnetic induction coil continuously wound and surrounding the entire circumference of at least a portion of magnetically permeable core material to thereby generate an inductive flux in said core material, and using said inductive flux to heat said well casing.

4. Method of constructing a tool for use in heating well casing, said method comprising surrounding a magnetically permeable core material with an electrically conductive induction coil about the entire circumference of at least a portion of said core material.

5. Tape wound core for an induction generating tool used in oil and gas wells comprising an electrically conductive coil surrounding a magnetically permeable core material, said core material comprising a continuous silicon steel material of a predetermined thickness, said coil being wound on a structural core pipe underlying said core material to a predetermined thickness so as to form said magnetically permeable core material.

6. Spiral wound coil for an induction generating tool used in oil and gas wells comprising a magnetically permeable core material and an electrically conductive induction coil surrounding said core material, said coil being a flat spirally wound coil with an insulative coating to prevent electrical conductance between adjacent coils.

7. Core end plate for an inductive tool having an electrically conductive coil surrounding magnetically permeable core material, said end plate being located on at least one end of said magnetically permeable core material, said end plate being made of magnetically permeable material and being operable to promote the transmission of magnetic flux lines generated by said core material.

8. Core end plate as in claim 7 wherein said end plate is made from a tape wound laminated high permeability steel sheet material.

9. Core end plate as in claim 7 wherein said end plate is made from a laminated stack of formed or shaped high permeability steel sheet material.

10. Core end plate as in claim 7 wherein said end plate is made from sintered high permeability powdered material.

11. Core end plate as in claim 7 wherein said end plate comprises a first member and a second member, said first and second members being joined by a mitered joint.

12. Temperature sensor for an inductive heat generating tool used in oil and gas wells which tool comprises magnetically permeable core material and an electrically conductive induction coil surrounding said core material, said temperature sensor comprising a coil wound around said core material, said coil being a bifilar wire twisted to cancel electromagnetically induced currents generated by said heat generating tool in said bifilar wire.

13. Temperature sensor for an inductive heat generating tool used in oil and gas wells, said tool comprising a magnetically permeable core material and an electrically conductive induction coil surrounding said core material, said temperature sensor comprising a sensor coil wound round said induction coil, said sensor coil being made from bifilar wire which is twisted to cancel electromagnetically inductive currents generated by said tool in said sensing wire and positioned within said core material and separated from said coil and a resistance measuring sensor to measure the change in resistance of said bifilar wire with an increase or decrease of said temperature in said core material.

14. Induction heat generating tool, said tool comprising at least two substantially identical modular reactor units, each of said reactor units comprising a central core tube, a tape wound core, a core end plate, an inductor coil, at least one bifilar wound temperature sensing coil, at least one magnetic flux sensor coil, at least one current sensing coil and at least one voltage sense coil.

15. Casing measurement apparatus to measure the temperature of casing in an oil or gas well subject to inductive heating by an inductive heating tool having an electrically conductive induction coil, said apparatus comprising a flux sensing coil, a current sensing coil, a voltage sensing coil, a core temperature sensing coil and an induction coil temperature sensing coil. In a preferred embodiment, signals representing flux, current, voltage and temperature of the core and electrically conductive induction coil determine the electrical power phase shift of the induced current in the casing which phase shift is proportional to the casing permeability and which permeability is calibrated with respect to temperature.

16. Inductive heating tool for inductively heating at least two concentric well casings of an oil or gas well comprising an inductive generating tool to generate magnetic flux, a tool flux sensor to measure the flux generated by said tool and a flux saturation sensor to determine the flux saturation of a first and inner well casing.

17. Method of inductively heating at least two concentric casings of an oil or gas well comprising generating flux from an inductive heating tool, determining the flux saturation value of the inner one of said at least two concentric casings, increasing the flux generated by said tool to a value above said flux saturation of said inner of said two concentric casings such that said increased flux generated by said tool will pass to and heat the outer one of said two concentric casings of said oil or gas well.

18. Centralizing stopper member for attachment to a downhole tool in a well casing comprising a collar attached to the periphery of said tool, said collar acting as a centrilizer for said tool and extending outwardly from said tool, said centrilizer being operable to center said tool within said casing.

19. A stopper member for attachment to the periphery of a downhole tool used in well casing, said stopper member comprising a collar attached to said periphery and extending outwardly from said tool, said stopper being operable to impede fluid flow between the induction tool and the casing thereby to reduce heat transfer from said casing.

20. A downhole tool used for heating a well casing and having a central bore therethrough, said bore extending the length of said tool and allowing the passage of electrical equipment from above to below said tool.

21. A well heating tool to heat well casing within an oil or gas well, said tool comprising oil and electrical connections within said tool, said oil being operable to insulate said electrical connections and to provide pressure compensation for electrical interface connectors between said tool and the downhole electrical cable.

22. A bladder in a downhole well heating tool for pressure compensating high dielectric oil used to fill said tool, said bladder being operable to equalize the internal pressure of said tool relative to external downhole pressure in said casing, said equalization taking place for compensating for the temperature coefficient of expansion of said dielectric oil over the operating temperature range of said tool.

23. Downhole electromagnetic induction tool for a well and a data acquisition and telemetry unit mounted on said tool, said data telemetry unit being operable to collect and transmit data relating to downhole conditions from said tool to the surface of said well, said data telemetry unit being operable to control electric power applied to said tool.

24. Downhole electromagnetic induction tool for generating flux into a well casing by power supplied by a single phase power supply, said tool comprising at least two reactor modules assembled together to utilise said single phase power supply, said reactor modules being connected in series or reverse-alternating-series thereby to lower downhole cable loss and minimize electromagnetic coupling losses between adjacent reactor modules.

25. Downhole electromagnetic induction tool for generating flux into a well casing by power supplied by a three phase power supply, said tool comprising at least two reactor modules assembled together to utilise said three phase power supply, said reactor modules being connected in parallel or in series-parallel.

26. Downhole electromagnetic induction tool as in claim 24 and further comprising at least one buss bar extending between said two(2) reactor modules, said buss bar being operable to allow opposite poles to be located adjacent to each other on each of said successive reactor modules.
